(19) United States
(12) Patent Application Publication
(10) Pub. No.: US 2026/0159084 A1
(43) Pub. Date: Jun. 11, 2026

(54) DRIVER ASSISTANCE APPARATUS

(71) Applicant: TOYOTA JIDOSHA KABUSHIKI KAISHA, Toyota-shi (JP)

(72) Inventors: Yuki IKEDA, Susono-shi (JP); Shogo ITO, Sunto-gun (JP)

(73) Assignee: TOYOTA JIDOSHA KABUSHIKI KAISHA, Toyota-shi (JP)

(21) Appl. No.: 19/366,689

(22) Filed: Oct. 23, 2025

(30) Foreign Application Priority Data
Dec. 6, 2024 (JP) 2024-213778

(51) Int. Cl. B60W 30/14; B60W 50/00; G06V 20/56; G06V 20/58

(52) U.S. Cl. CPC B60W 30/146; B60W 50/00; G06V 20/58; G06V 20/588; B60W 2050/0083; B60W 2420/403; B60W 2552/30; B60W 2552/53; B60W 2554/802; B60W 2555/60; G06V 2201/07

(57) ABSTRACT

An ECU of the driver assistance apparatus performs deceleration assistance for automatically decelerating a vehicle. When the ECU detects driver’s deceleration operation for decelerating the vehicle, it specifies a deceleration-requiring target that causes the driver to decelerate the vehicle. The ECU learns deceleration assistance start position information that indicates a deceleration assistance start position corresponding to a position at which the deceleration operation is started, in association with the specified deceleration-requiring target. After learning, the ECU performs the deceleration assistance when the vehicle reaches the deceleration assistance start position. When the deceleration-requiring target that has been learned in association with the deceleration assistance start position information is determined to have changed, the ECU deletes the deceleration assistance start position information.

### TECHNICAL FIELD

The present disclosure relates to a driver assistance apparatus configured to execute a deceleration control including a process of learning a position at which a driver decelerates a vehicle, and a process of automatically decelerating the vehicle when the vehicle passes through the learned position.

### BACKGROUND

One of conventional apparatuses of this kind (hereinafter, simply referred to as a “conventional apparatus”) generates map information by associating a change in a driver’s driving operation with position information specifying a position of the change.

The conventional apparatus utilizes the generated map information for vehicle control (refer to Japanese Patent Application Laid-Open No. 2009-103570).

### SUMMARY

However, for example, when the driver makes a deceleration operation, it is considerably difficult to determine whether the deceleration operation is an incidental operation or an operation due to a driving circumstance (e.g., a deceleration requiring circumstance such as a stop sign indicating a temporary stop and a curved road). Therefore, in order to generate map information as in the conventional apparatus, it is necessary to statistically determine that the deceleration operation is an operation attributable to a driving circumstance, and for this purpose, a large amount of data must be collected. In addition, after the map information was once generated, if a driving circumstance has been changed, it is necessary to statistically determine whether the driving circumstance has actually changed, and for this purpose, a large amount of data is required to be collected. Accordingly, for a long period from a time point at which the driving circumstance has actually changed until a time point at which the map information is updated, unnecessary vehicle control (e.g., unnecessary deceleration control) may be executed.

The present disclosure is made to cope with the problem described above. That is, one of the objects of the present disclosure is to provide a driver assistance apparatus and a driver assistance method, that can early stop performing the deceleration assistance based on a traveling state that is a state which has changed. Note that “step” may hereinafter be expressed as “S”.

One of aspects of the driver assistance apparatuses according to the present disclosure comprises a controller (10) configured to be able to perform deceleration assistance for automatically decelerating a vehicle.

The controller is configured to:

specify a deceleration-requiring target causing a deceleration operation which is a driver’s driving operation for decelerating the vehicle (S420);

learn deceleration assistance start position information that indicates a deceleration assistance start position corresponding to a position at which the deceleration operation is started, in association with the specified deceleration-requiring target (S455);

perform the deceleration assistance when the vehicle reaches the deceleration assistance start position indicated by the deceleration assistance start position information that has been learned (S530); and

when the deceleration-requiring target that has been learned in association with the deceleration assistance start position information is determined to have changed (S520: Yes), delete the deceleration assistance start position information corresponding to the deceleration-requiring target that is determined to have changed (S540).

According to this apparatus, when it is determined that the deceleration-requiring target has changed after the deceleration assistance start position information was learned, the deceleration assistance start position information corresponding to the deceleration-requiring target that is determined to have changed is immediately deleted. Therefore, when the vehicle passes through the traveling state in which the deceleration-requiring target has changed, the deceleration assistance that corresponds to the driver’s deceleration operation due to the deceleration-requiring target before the change is no longer performed. Thus, a frequency of unnecessary deceleration assistance can be reduced.

Notably, in the above description, in order to facilitate understanding of the present disclosure, the constituent elements corresponding to those of an embodiment which will be described later are accompanied by parenthesized symbols and/or names which are used in the embodiment; however, the constituent elements of the disclosure are not limited to those in the embodiment defined by the symbols and/or names. The present disclosure also covers a driver assistance method executed by the driver assistance apparatus, and a non-transitory computer readable medium having stored therein a program that causes a computer mounted on the vehicle to execute steps in the driver assistance method.

### BRIEF DESCRIPTION OF THE DRAWINGS

FIG. 1 is a schematic diagram of a driver assistance apparatus according to an embodiment of the present disclosure.

FIG. 2 is a plan view of an intersection and a vehicle, for describing deceleration assistance.

FIG. 3A is an example of a table of “a deceleration-requiring target and a traveling state indication value” stored in a non-volatile memory.

FIG. 3B is an example of “a deceleration-requiring target and a learning value” stored in a non-volatile memory.

FIG. 4 shows a routine executed by a CPU of the driver assistance ECU shown in FIG. 1.

FIG. 5 shows another routine executed by the CPU of the driver assistance ECU shown in FIG. 1.

FIG. 6 shows still another routine executed by the CPU of the driver assistance ECU shown in FIG. 1.

### DETAILED DESCRIPTION

### (Configuration)

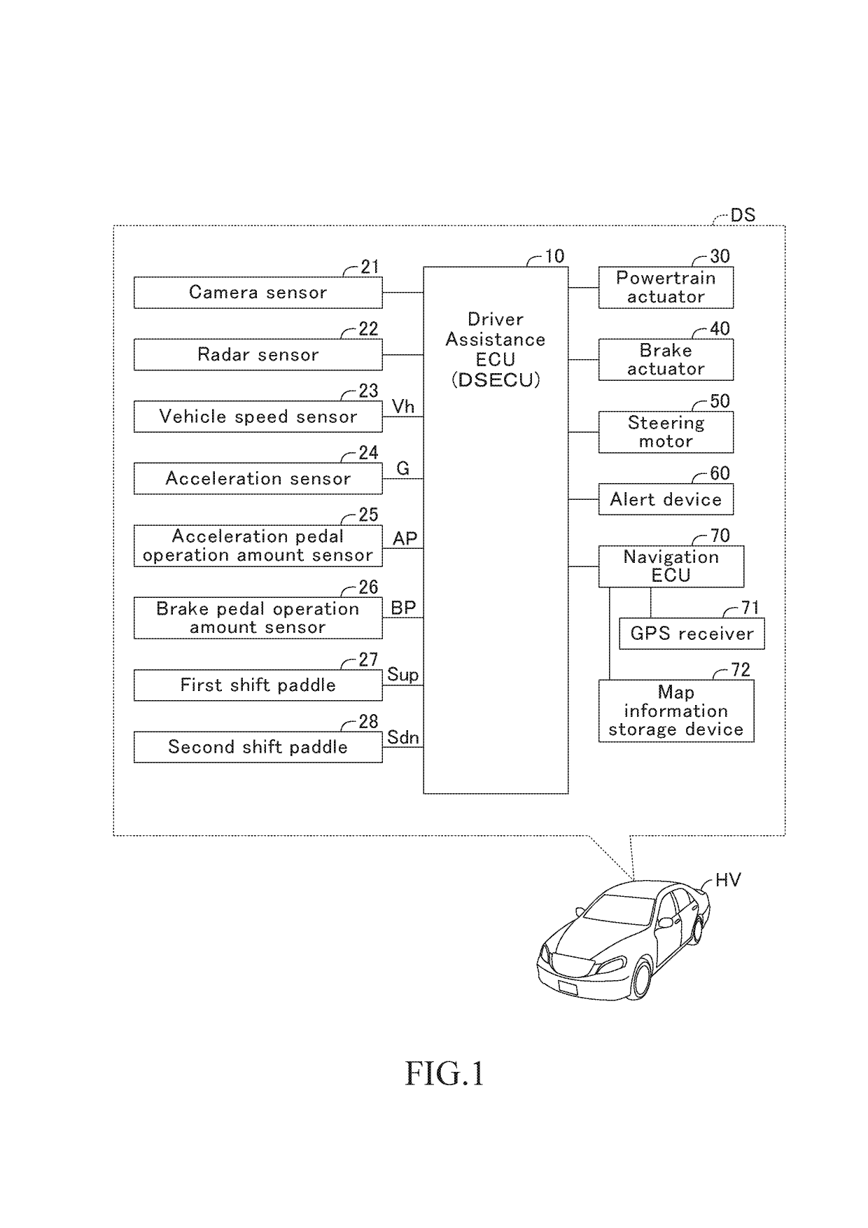

A driver assistance apparatus (hereinafter, referred to as an "apparatus DS") according to an embodiment of the present disclosure comprises the elements shown in FIG. 1. The apparatus DS is applied to (i.e., is mounted on) a vehicle HV. The vehicle HV may be a vehicle having an internal combustion engine as a drive source, a vehicle having an electric motor as a drive source (namely, an electric vehicle), or a hybrid vehicle.

In the present specification, an ECU means an electronic control device/unit comprising a microcomputer. The microcomputer includes a CPU (i.e., a processor), a ROM (i.e., a non-transitory storage medium), a RAM, a non-volatile memory in which data can be written, and an interface. The CPU realizes various functions by executing routines (e.g., instructions) stored in the memory (i.e., the ROM). The ECU may also be referred to as a controller or a computer.

The driver assistance ECU 10 executes deceleration assistance control, which will be described later, as driver assistance control. The driver assistance ECU 10 is connected to the elements described below, and transmits signals to, or receives signals from, those elements. The driver assistance ECU 10 may be implemented by multiple ECUs.

The camera sensor 21 is configured to obtain image data by capturing an image of a scene surrounding the vehicle HV including a scene in front of the vehicle HV, every time a predetermined time elapses. The driver assistance ECU 10 is configured to obtain, based on the image data, positional information including information indicative of a positional relationship between the vehicle HV and an object present around the vehicle HV as well as a positional relationship between the vehicle HV and various lines painted on a road surface (e.g., a lane demarcation line). Furthermore, the driver assistance ECU 10 is configured to obtain, based on the image data, information on a driving circumstance (i.e., environment) of the vehicle HV. The information on the driving circumstance includes information indicating whether a deceleration-requiring target (or factor) is present, and information specifying a type of the deceleration-requiring target. These pieces of information obtained based on the image data acquired by the camera sensor 21 may be referred to as “camera information.”

The deceleration-requiring target represents the driving circumstance indicating that the vehicle HV is required to decelerate before the vehicle HV reaches the deceleration-requiring target. In other words, the deceleration-requiring target is a target serving as a factor which causes the driver of the vehicle HV to perform a deceleration operation, which is a driving operation to decelerate the vehicle HV. The deceleration-requiring target includes at least one of a stop sign indicating a temporary stop, a stop line indicating a temporary stop, a curve (curved road) present in front of the vehicle HV, a railroad crossing signal, a gate provided at an entrance to a toll road, a priority road intersecting with a traveling lane of the vehicle HV, and other traffic signs.

The radar sensor 22 is a well-known sensor configured to obtain information on an object present in front of (or ahead of) the vehicle, using electromagnetic waves in a millimeter-wave band. The radar sensor 22 sends millimeter wave information on the transmitted and received millimeter waves to the driver assistance ECU 10. The driver assistance ECU 10 obtains “radar information” based on the millimeter wave information. The radar information includes a distance to an object, an azimuth of the object, and a relative speed of the object.

The driver assistance ECU 10 generates fusion information by fusing the camera information with the radar information.

The vehicle speed sensor 23 is configured to output a signal indicative of a speed (i.e., vehicle speed) Vh of the vehicle HV.

The acceleration sensor 24 is configured to output a signal indicative of an acceleration G of the vehicle HV in a front-rear direction.

The acceleration pedal operation amount sensor 25 is configured to output a signal indicative of an acceleration pedal operation amount AP of the vehicle HV.

The brake pedal operation amount sensor 26 is configured to output a signal indicative of a brake pedal operation amount BP of the vehicle HV.

The first shift paddle 27 is disposed on a steering wheel (not shown), and outputs a signal Sup for shifting up a gear position of a transmission (not shown) when pressed by the driver. When the driver assistance ECU 10 receives the signal Sup, the driver assistance ECU 10 causes the transmission to shift up its gear position by one stage.

The second shift paddle 28 is disposed on the steering wheel (not shown), and outputs a signal Sdn for shifting down a gear position of the transmission when pressed by the driver. When the driver assistance ECU 10 receives the signal Sdn, the driver assistance ECU 10 causes the transmission to shift down its gear position by one stage.

The driver assistance ECU 10 is further connected to the powertrain actuator 30, the brake actuator 40, the steering motor (i.e., steering actuator) 50, the alert device 60, and the navigation ECU 70.

The powertrain actuator 30 drives an unillustrated “powertrain device including the drive source and the transmission” of the vehicle HV so as to adjust a driving force of the vehicle HV.

The brake actuator 40 drives an unillustrated brake device of the vehicle HV so as to adjust a braking force applied to the vehicle HV.

Accordingly, the driver assistance ECU 10 drives the powertrain actuator 30 and the brake actuator 40 so as to be able to automatically decelerate the vehicle HV.

The steering motor 50 applies a torque to an unillustrated steering mechanism of the vehicle HV so as to vary a steering angle of unillustrated steered wheels of the vehicle HV.

The alert device 60 includes a display device and an alert sound generating device. The alert device 60 causes the display device to display a predetermined visual alert and causes the alert sound generating device to generate an alert sound, in response to an instruction signal from the driver assistance ECU 10.

The navigation ECU 70 is connected to the GPS receiver 71 and the map information storage device 72. The navigation ECU 70 obtains a current position of the vehicle HV based on GPS signals received by the GPS receiver 71. Based on the obtained current position and the map information stored in the map information storage device 72, the navigation ECU 70 can provide the driver assistance ECU 10 with the information on the driving circumstance (i.e., presence/absence of a deceleration-requiring target and a type of the deceleration-requiring target). Note that the navigation ECU 70 may obtain updated map information through a communication with an external device, and update the map information stored in the map information storage device 72 based on the obtained updated map information.

### (Outline of operation)

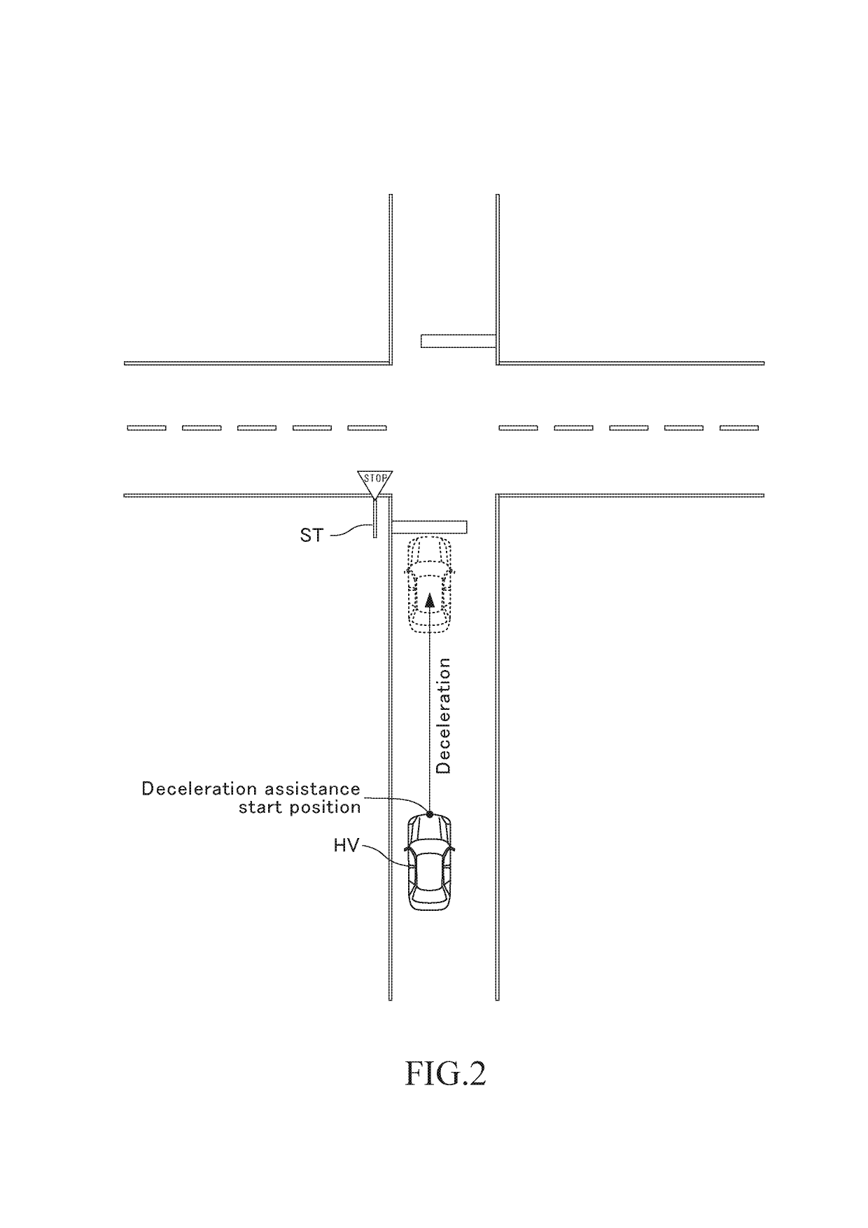

The apparatus DS detects (i.e., recognizes or specifies) the deceleration-requiring target, based on, for example, the image data. FIG. 2 illustrates an example in which the stop sign ST indicating a temporary stop is detected as the deceleration-requiring target.

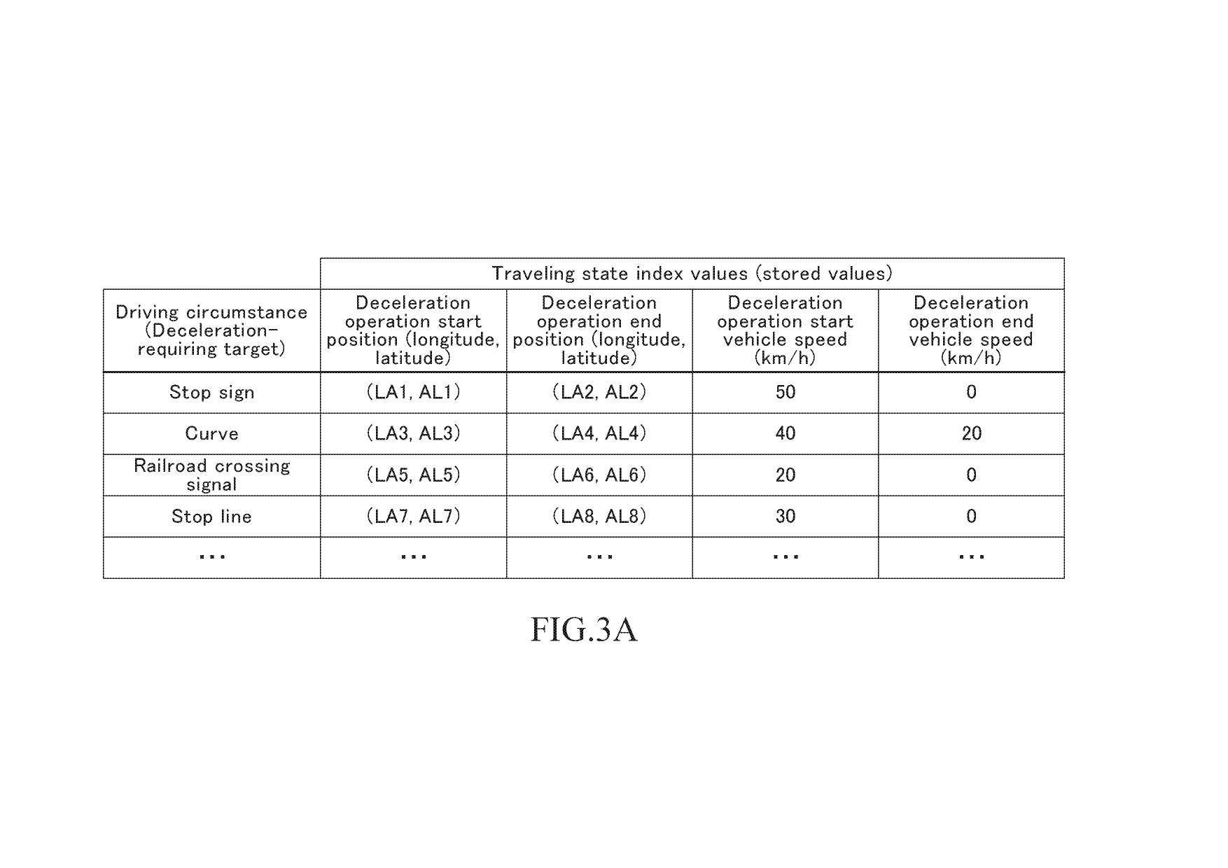

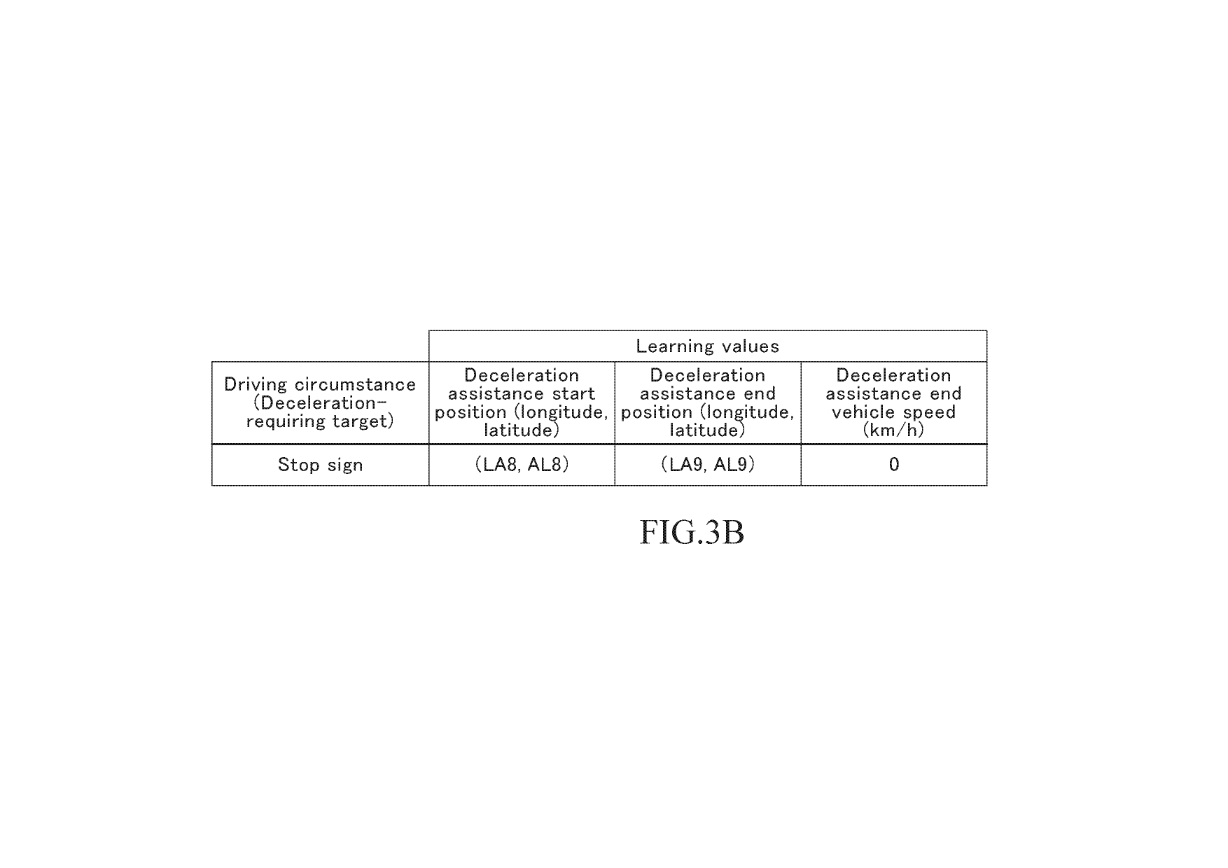

When the driver of the vehicle HV starts performing the deceleration operation, the apparatus DS determines whether the driving circumstance in front of the vehicle HV includes the deceleration-requiring target. The deceleration operation includes, for example, an operation of depressing the brake pedal and an operation of performing a shift-down of the transmission. When the driving circumstance in front of the vehicle HV includes the deceleration-requiring target, the apparatus DS stores a set of traveling state index values while associating the set of the traveling state index values with (the type of) the deceleration-requiring target, as in an example shown in FIG. 3A. The traveling state index values include a deceleration operation start position (represented by longitude and latitude), a deceleration operation end position (represented by longitude and latitude), a vehicle speed of when (or at the time when) the deceleration operation is started (namely, deceleration operation start vehicle speed), and a vehicle speed of when (or at the time when) the deceleration operation is ended (namely, deceleration operation end vehicle speed).

When the apparatus DS obtains a data number threshold Cth or more sets of the stored data (i.e., the data number threshold Cth or more of sets of the traveling state index values) whose deceleration operation start positions are regarded as being the same as each other, the apparatus DS generates learning values based on the obtained sets of the stored data, and stores in the non-volatile memory (i.e., performs learning) the generated learning values while associating the generated learning values with the deceleration-requiring target.

As in an example shown in FIG. 3B, the learning values include deceleration assistance start position information indicating a deceleration assistance start position represented by longitude and latitude, deceleration assistance end position information indicating a deceleration assistance end position represented by longitude and latitude, and deceleration assistance end vehicle speed information indicating a deceleration assistance end vehicle speed.

The deceleration assistance start position represents an average position of the deceleration operation start positions included in the stored data.

The deceleration assistance end position represents an average position of the deceleration operation end positions included in the stored data.

The deceleration assistance end vehicle speed represents an average vehicle speed of the deceleration operation end vehicle speeds included in the stored data.

It should be noted that the learning values are required to include at least deceleration assistance start position information and a parameter such as a target deceleration that can specify the content of the deceleration assistance. However, the learning values are not limited to the foregoing example.

Thereafter, when the vehicle HV reaches the deceleration assistance start position indicated by the learned deceleration assistance start position information, the apparatus DS performs the deceleration assistance to decelerate the vehicle HV at a constant deceleration in such a manner that vehicle speed at the deceleration assistance end position coincides with the deceleration assistance end vehicle speed. Thus, the learned values described above may be considered as parameters specifying the content of the deceleration assistance.

The conventional apparatus is not configured to obtain the learning values while associating the learning values with the deceleration-requiring target. Therefore, if the driver performs an acceleration operation after a time point at which the vehicle HV reaches the learned deceleration assistance start position, the conventional apparatus cannot immediately determine whether the acceleration operation is an incidental operation or an operation due to a change in the driving circumstances. Accordingly, the conventional apparatus deletes the learning values only when it confirms the change in the driving circumstances after such an acceleration operation is repeated a large number of times. Consequently, a time period until the learning values are deleted becomes long, and thus, unnecessary deceleration assistance may be performed in that time period.

In contrast, when the vehicle HV reaches the learned deceleration assistance start position, if the apparatus DS determines that a deceleration-requiring target that has been associated with the deceleration assistance start position differs from a deceleration-requiring target currently recognized (identified) at that time, the apparatus DS immediately discards the learning values (i.e., deceleration assistance start position information, deceleration assistance end position information, and deceleration assistance end vehicle speed information, etc.) associated with the deceleration assistance start position. This can reduce the frequency of unnecessary deceleration assistance.

### (Specific operation)

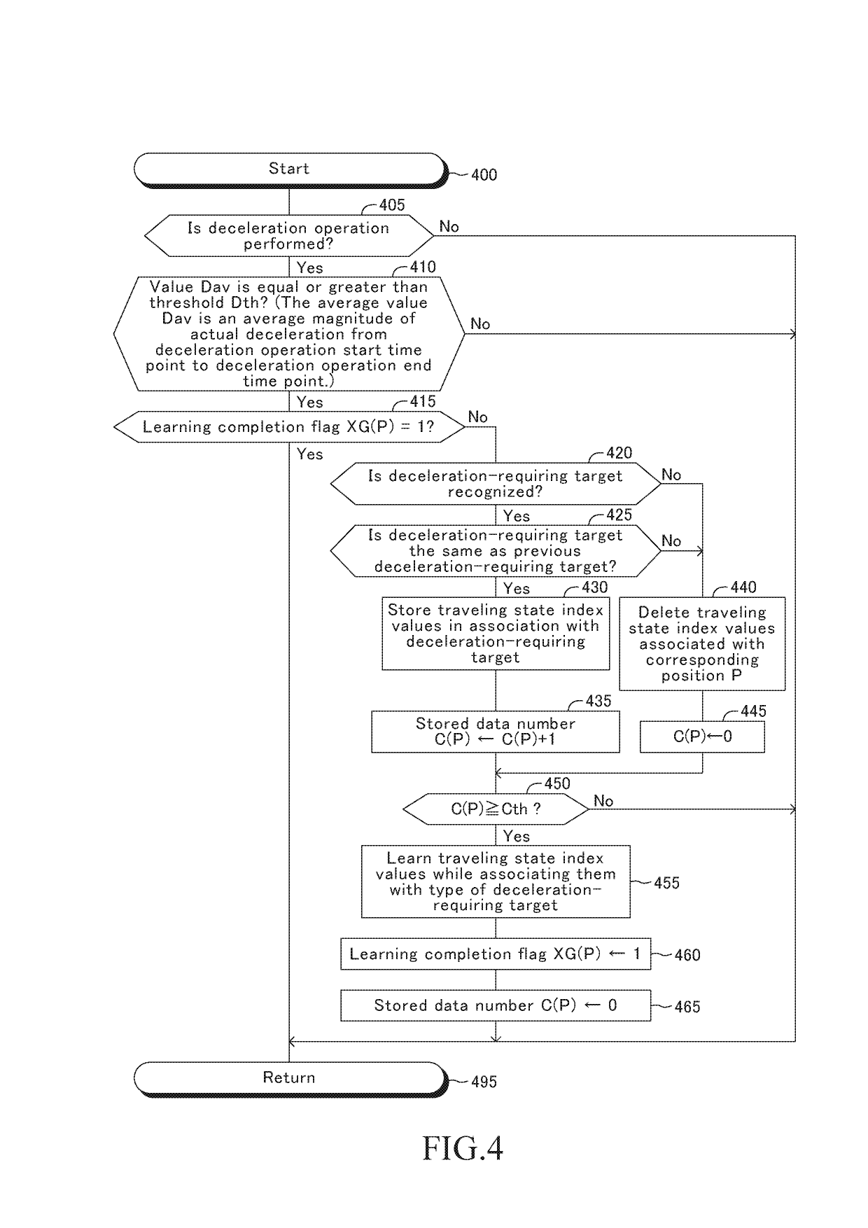

The CPU of the driver assistance ECU 10 executes routines illustrated in FIGS. 4 - 6 every time a predetermined time elapses.

At an appropriate timing, the CPU starts processing from S400 shown in FIG. 4, and proceeds to S405. At S405, the CPU determines whether or not the deceleration operation is performed by the driver. The deceleration operation is at least one of a braking operation to increase the brake pedal operation amount BP from “0”, and a shift-down operation to cause the second shift paddle 28 to generate the signal Sdn.

When the deceleration operation is performed, the CPU proceeds from S405 to S410 so as to determine whether or not an average value Dav is equal or greater than a threshold Dth. The average value Dav is an average magnitude of an actual deceleration (that is acceleration G) during a period from the deceleration operation start time point to the deceleration operation end time point. It should be noted that the CPU may determine, at S410, whether or not the magnitude of an actual deceleration immediately after the deceleration operation start time point is equal to or greater than a predetermined threshold. Furthermore, the process of S410 may be omitted. In this case, when the CPU makes a “Yes” determination at S405, it proceeds to S415 described later.

When the average value Dav is smaller than the threshold Dth, the CPU directly proceeds from S410 to S495 so as to terminate the present routine tentatively. In contrast, when the average value Dav is greater than or equal to the threshold Dth, the CPU proceeds from S410 to S415. At S415, the CPU determines whether or not the “learning values, that have, as the deceleration assistance start position, a position P that substantially corresponds to the position of the vehicle HV at the present deceleration operation start time point” have already been obtained and stored. The position P that substantially corresponds to the position of the vehicle HV at the present deceleration operation start time point is a position within a predetermined distance (e.g., 10 m) from the position of the vehicle HV at the present deceleration operation start time point, and is hereinafter referred to as a “corresponding position”. That is, at S415, the CPU determines whether or not the learning for the deceleration assistance for the corresponding position P has been completed, by determining whether or not a value of a learning completion flag XG(P) is “1”. When the value of the learning completion flag XG(P) is “1”, the CPU proceeds from S415 to S495 to terminate the present routine tentatively.

In contrast, when the value of the learning completion flag XG(P) is “0” (that is, when the learning for the deceleration assistance for the corresponding position P has not been completed), the CPU proceeds from S415 to S420 to determine whether or not one of the deceleration-requiring targets whose type is predetermined is successfully recognized and specified. When one of the deceleration-requiring targets is successfully recognized and specified, the CPU proceeds from S420 to S425. At S425, the CPU determines whether or not the deceleration-requiring target that is currently recognized is the same as the deceleration-requiring target (that is, the previous deceleration-requiring target) that was recognized at the time when the vehicle HV previously passed through the position regarded as substantially the same as the corresponding position P.

When the deceleration-requiring target currently recognized is the same as the previous deceleration-requiring target, the CPU proceeds from S425 to S430 so as to store the traveling state index values while associating the traveling state index values with the deceleration-requiring target in the non-volatile memory, as illustrated in FIG. 3A. Subsequently, the CPU increments the value of a stored data number C(P) for the corresponding position P by “1” at S435, and then proceeds to S450.

In contrast, when the CPU makes a “No” determination at one of S420 and S425, it proceeds from the step at which it makes the “No” determination to S440 so as to delete all of the traveling state index values that are stored in association with the corresponding position P. Subsequently, the CPU proceeds to S445 to set the value of the stored data number C(P) to “0”. Thereafter, the CPU proceeds to S450.

At S450, the CPU determines whether or not the value of the stored data number C(P) is greater than or equal to a data number threshold Cth. That is, the CPU determines whether or not sufficient data for learning the deceleration assistance for the corresponding position P is stored. When the value of the stored data number C(P) is smaller than the data number threshold Cth, the CPU proceeds directly from S450 to S495 to terminate the present routine tentatively.

In contrast, when the value of the stored data number C(P) is greater than or equal to the data number threshold Cth, the CPU proceeds from S450 to S455. At S455, the CPU generates the learning values (that is, the parameters that can specify the content of the deceleration assistance) based on the traveling state index values for the corresponding position P, and stores the generated learning values in the non-volatile memory in association with (i.e., while associating the generated learning values with) the type of the deceleration-requiring target (see FIG. 3B). Subsequently, the CPU sets the value of the learning completion flag XG(P) to “1” at S460, and further sets the value of the stored data number C(P) to “0” at S465. Thereafter, the CPU proceeds to S495. In this manner, the content of the deceleration assistance is learned in association with the deceleration-requiring target.

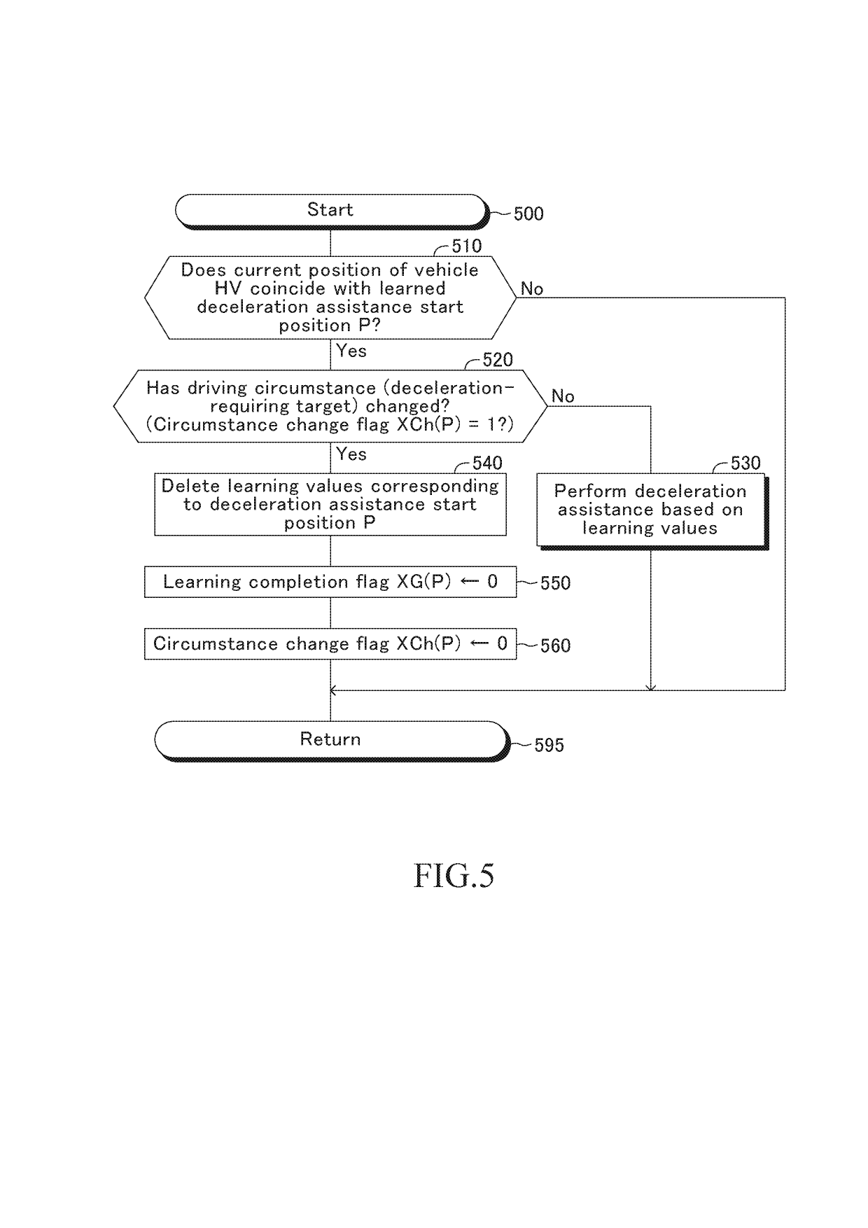

At an appropriate timing, the CPU starts processing from S500 shown in FIG. 5, and proceeds to S510. At S510, the CPU determines whether or not the current position of the vehicle HV coincides with a position P of any of the deceleration assistance start positions indicated by the deceleration assistance start position information that has been learned. When the current position of the vehicle HV does not coincide with any of the learned deceleration assistance start positions, the CPU proceeds directly from S510 to S595 to terminate the present routine tentatively. That is, in this case, the deceleration assistance is not performed.

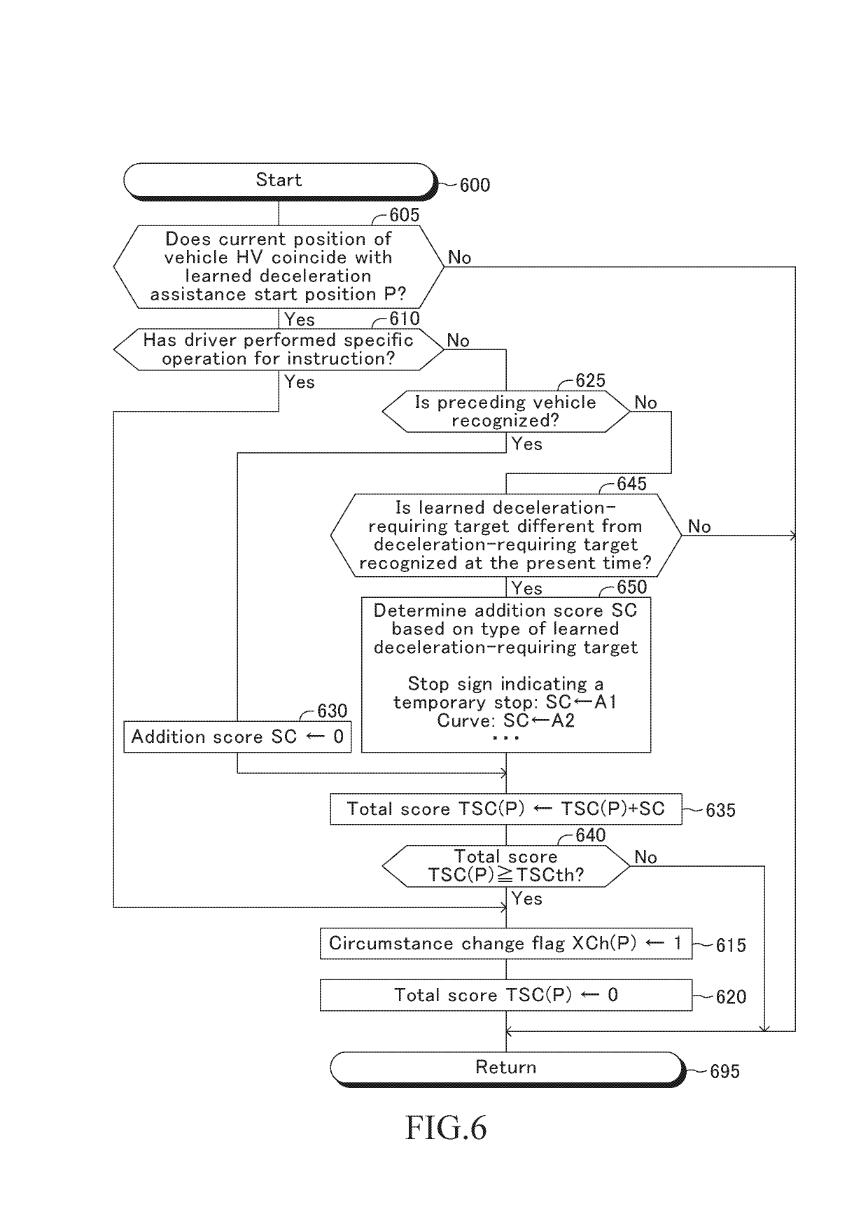

In contrast, when the current position of the vehicle HV coincides with any position P among the learned deceleration assistance start positions, the CPU proceeds directly from S510 to S520. At S520, the CPU determines whether or not the driving circumstance (that is, the deceleration-requiring target) corresponding to the position P has changed by determining whether or not a value of a circumstance change flag XCh(P) for the position P is equal to “1”. As described later, the value of the circumstance change flag XCh(P) is set to “1” when it is determined that the driving circumstance (that is, the deceleration-requiring target) corresponding to the position P has changed (see S615 shown in FIG. 6).

When the value of the circumstance change flag XCh(P) is “0” (that is, when the deceleration-requiring target has not changed), the CPU proceeds from S520 to S530. At S530, the CPU performs the deceleration assistance based on the learning values corresponding to the deceleration assistance start position P (namely, the values indicating the content of the learned deceleration assistance such as the deceleration assistance start position information, the deceleration assistance end position information, and the deceleration assistance end vehicle speed information), as described above. Thereafter, the CPU proceeds to S595.

In contrast, when the value of the circumstance change flag XCh(P) is “1” (that is, when the deceleration-requiring target has changed), the CPU proceeds from S520 to S540. At S540, the CPU deletes the learning values corresponding to the deceleration assistance start position P (namely, the values indicating the content of the learned deceleration assistance such as the deceleration assistance start position information, the deceleration assistance end position information, and the deceleration assistance end vehicle speed information). Subsequently, the CPU proceeds to S550 so as to set the value of the learning completion flag XG(P) to “0”, and proceeds to S560 so as to set the value of the circumstance change flag XCh(P) to “0”. Thereafter, the CPU proceeds to S595.

At an appropriate timing, the CPU starts processing from S600 shown in FIG. 6, and proceeds to S605. At S605, the CPU determines whether or not the current position of the vehicle HV coincides with a position P of any of the deceleration assistance start positions indicated by the deceleration assistance start position information that has been learned. When the current position of the vehicle HV does not coincide with any of the learned deceleration assistance start positions, the CPU proceeds directly from S605 to S695 to terminate the present routine tentatively.

In contrast, when the current position of the vehicle HV coincides with any position P among the learned deceleration assistance start positions, the CPU proceeds from S605 to S610. At S610, the CPU determines whether or not the driver has performed a specific operation to instruct or indicate that the driving circumstance (that is, the deceleration-requiring target) has changed. For example, the specific operation may be an operation to continuously press at least one of the first shift paddle 27 and the second shift paddle 28 for a predetermined time (e.g., 2 seconds) or more. Also, the specific operation may be, for example, an operation to press at least one of the first shift paddle 27 and the second shift paddle 28 for predetermined times (e.g., 4 times) or more within a predetermined time (e.g., 3 seconds).

Note that, the specific operation to instruct that the driving circumstance (that is, the deceleration-requiring target) has changed is not limited to the operation on the first shift paddle 27 and/or the second shift paddle 28. For example, if the apparatus DS is connected to a specific switch (not shown), an operation on that switch may be regarded/treated as the above-described specific operation to instruct that the driving circumstance has changed.

When such a specific operation is detected, the CPU proceeds from S610 to S615 so as to set the value of the circumstance change flag XCh(P) for the position P to “1”. Subsequently, the CPU proceeds to S620 so as to set a value of a total score TSC(P) to “0”, and proceeds to S695.

When the specific operation is not detected at S610, the CPU proceeds from S610 to S625 so as to determine whether or not a preceding vehicle is recognized/detected based on the image data. When the preceding vehicle is recognized, the CPU proceeds from S625 to S630 so as to set a value of an addition score SC to “0”. Subsequently, the CPU proceeds to S635 so as to increase the value of the total score TSC(P) by the addition score SC. That is, the CPU adds the addition score SC to the current total score TSC(P) so as to update the total score TSC(P). Note that, when the preceding vehicle is being recognized, the addition score SC is “0”, and thus, the the total score TSC(P) is not increased at S635. This is because, when the preceding vehicle is being recognized, it is difficult to determine, based on the image data, whether or not the driving circumstance has changed.

Subsequently, the CPU proceeds to S640 so as to determine whether or not the total score TSC(P) is greater than or equal to a total score threshold TSCth. When the total score TSC(P) is neither greater than nor equal to the total score threshold TSCth, the CPU proceeds directly from S640 to S695.

In contrast, when the total score TSC(P) is greater than or equal to the total score threshold TSCth, the CPU determines that the driving circumstance (that is, the deceleration-requiring target) for the position P has changed. In this case, the CPU executes the “processes of S615 and S620” described above. Thereafter, the CPU proceeds to S695.

When the CPU proceeds to S625, if the preceding vehicle is not recognized, the CPU proceeds from S625 to S645. At S645, the CPU determines whether or not the deceleration-requiring target associated with the deceleration assistance start position P that corresponds to the current position is different from the deceleration-requiring target recognized/specified based on the image data at the present time. Note that, when the deceleration-requiring target is not recognized at the present time, the CPU also determines that the deceleration assistance start position P that corresponds to the current position is different from the deceleration-requiring target recognized/specified based on the image data at the present time. That is, in this case as well, the CPU determines that the driving circumstance (namely, the deceleration-requiring target) for the deceleration assistance start position P has changed.

When the deceleration-requiring target associated with the deceleration assistance start position P that corresponds to the current position is not different from (i.e., is the same as) the deceleration-requiring target recognized/specified based on the image data at the present time, the CPU proceeds from S645 directly to S695.

In contrast, when the deceleration-requiring target associated with the deceleration assistance start position P that corresponds to the current position is different from the deceleration-requiring target recognized/specified based on the image data at the present time, the CPU proceeds from S645 to S650. At S650, the CPU determines the addition score SC based on the type of the deceleration-requiring target that has been learned in association with the deceleration assistance start position P. For example, since the stop sign indicating a temporary stop and the railroad crossing signal are the deceleration-requiring targets that are relatively accurately recognized based on the image data, the addition score SC for them is set to a relatively large value A1. Whereas, since the curve is the deceleration-requiring target that is not often accurately recognized based on the image data, the addition score SC for it is set to a relatively small value A2 that is smaller than the value A1. In this manner, the addition score SC for the deceleration-requiring target that is recognized with high accuracy based on the image data is set to a value greater than a value to which the addition score SC for the deceleration-requiring target that is recognized with low accuracy based on the image data is set. Thereafter, the CPU proceeds to S635.

Accordingly, when the total score TSC(P), which becomes greater as a possibility that the deceleration-requiring target recognized/specified based on the image data at the present time is different from deceleration-requiring target that has been learned for the position P becomes higher, becomes greater than or equal to the total score threshold TSCth, the driving circumstance (that is, the deceleration-requiring target) for the position P is determined to have changed, and the value of the circumstance change flag XCh(P) is set to “1”.

As has been described, the apparatus DS specifies the deceleration-requiring target when the deceleration operation is performed by the driver, and it learns the content of the deceleration assistance corresponding to the deceleration operation (that is, it learns the deceleration assistance start position information, the deceleration assistance end position information, and the deceleration assistance end vehicle speed information) in association with the specified deceleration-requiring target. When the apparatus DS determines that the already learned deceleration-requiring target for the deceleration assistance start position has changed, it deletes the learned deceleration-requiring target. Therefore, the deceleration assistance corresponding to the deceleration-requiring target before the change is immediately prevented from being performed.

The present disclosure is not limited to the above-described embodiment, and various modifications such as those described below may be adopted within the scope of the disclosure. For example, the present disclosure can be applied to a vehicle in which the driving mode has transitioned from autonomous driving mode to driver operation mode in an autonomous vehicle.

The apparatus DS may specify the deceleration-requiring target based on map information stored in the map information storage device 72. Furthermore, when the map information stored in the map information storage device 72 is updated, the apparatus DS may detect that the deceleration-requiring target has changed based on the updated map information, and may immediately delete the learning values corresponding to a position of the changed deceleration-requiring target.

What is claimed is:

1. A driver assistance apparatus comprising a controller configured to perform deceleration assistance for automatically decelerating a vehicle, wherein said controller is configured to:
specify a deceleration-requiring target causing a deceleration operation which is a driver’s driving operation for decelerating said vehicle;
learn deceleration assistance start position information that indicates a deceleration assistance start position corresponding to a position at which said deceleration operation is started, in association with said specified deceleration-requiring target;
perform said deceleration assistance when said vehicle reaches said deceleration assistance start position indicated by said deceleration assistance start position information that has been learned; and
when said deceleration-requiring target that has been learned in association with said deceleration assistance start position information is determined to have changed, delete said deceleration assistance start position information corresponding to said deceleration-requiring target that is determined to have changed.

2. The driver assistance apparatus according to claim 1, wherein,
said deceleration-requiring target includes at least one of a stop sign indicating a temporary stop, a stop line indicating a temporary stop, a curve, a railroad crossing signal, a gate provided at an entrance to a toll road, and a priority road intersecting with a traveling lane of said vehicle, each of which is present in front of said vehicle.

3. The driver assistance apparatus according to claim 2, wherein,
said controller is configured to:
determine a content of said deceleration assistance based on a traveling state index value indicating a traveling state of said vehicle while said deceleration operation is performed, and learn said content of said deceleration assistance in association with said deceleration assistance start position information; and
perform said deceleration assistance in accordance with said content of said deceleration assistance that has been learned.

4. The driver assistance apparatus according to claim 3, wherein,
said controller is configured to:
specify said deceleration-requiring target based on image data obtained by a camera mounted on said vehicle;
when said deceleration-requiring target that is specified based on said image data at a time when said vehicle reaches said deceleration assistance start position indicated by said deceleration assistance start position information is different from said deceleration-requiring target that has been learned in association with said deceleration assistance start position information indicating said deceleration assistance start position which said vehicle reaches, determine an addition score based on a type of said deceleration-requiring target that has been learned;
when said vehicle reaches said deceleration assistance start position, obtain a total score by adding said addition score; and
when said total score becomes greater than a predetermined score threshold, determine that said deceleration-requiring target that has been learned in association with said deceleration assistance start position information indicating said deceleration assistance start position which said vehicle reaches has changed.

5. The driver assistance apparatus according to claim 4, wherein,
said controller is configured to set said addition score to zero when a preceding vehicle present in front of said vehicle is included in said image data obtained when said vehicle reaches said deceleration assistance start position indicated by said deceleration assistance start position information that has been learned.

6. A driver assistance method for performing deceleration assistance for automatically decelerating a vehicle, comprising:
a step of specifying a deceleration-requiring target causing a deceleration operation which is a driver’s driving operation for decelerating said vehicle;
a step of learning deceleration assistance start position information that indicates a deceleration assistance start position corresponding to a position at which said deceleration operation is started, in association with said specified deceleration-requiring target;
a step of performing said deceleration assistance when said vehicle reaches said deceleration assistance start position indicated by said deceleration assistance start position information that has been learned; and
a step of deleting, when said deceleration-requiring target that has been learned in association with said deceleration assistance start position information is determined to have changed, said deceleration assistance start position information corresponding to said deceleration-requiring target that is determined to have changed.

7. The driver assistance method according to claim 6, wherein,
said deceleration-requiring target includes at least one of a stop sign indicating a temporary stop, a stop line indicating a temporary stop, a curve, a railroad crossing signal, a gate provided at an entrance to a toll road, and a priority road intersecting with a traveling lane of said vehicle, each of which is present in front of said vehicle.

8. The driver assistance method according to claim 7 further comprising:
a step of determining a content of said deceleration assistance based on a traveling state index value indicating a traveling state of said vehicle while said deceleration operation is performed, and of learning said content of said deceleration assistance in association with said deceleration assistance start position information; and
wherein,
said step of performing said deceleration assistance is a step of performing said deceleration assistance in accordance with said content of said deceleration assistance that has been learned.

9. The driver assistance method according to claim 8 further comprising,
said step of specifying said deceleration-requiring target is a step of specifying said deceleration-requiring target based on image data obtained by a camera mounted on said vehicle;
and wherein,
said method further comprising:
a step of determining an addition score based on a type of said deceleration-requiring target that has been learned, when said deceleration-requiring target that is specified based on said image data at a time when said vehicle reaches said deceleration assistance start position indicated by said deceleration assistance start position information is different from said deceleration-requiring target that has been learned in association with said deceleration assistance start position information indicating said deceleration assistance start position which said vehicle reaches;
a step of obtaining a total score by adding said addition score, when said vehicle reaches said deceleration assistance start position; and
a step of determining that said deceleration-requiring target that has been learned in association with said deceleration assistance start position information indicating said deceleration assistance start position which said vehicle reaches has changed, when said total score becomes greater than a predetermined score threshold.

10. The driver assistance method according to claim 9, wherein,
said step of determining said addition score includes a step of setting said addition score to zero when a preceding vehicle present in front of said vehicle is included in said image data obtained when said vehicle reaches said deceleration assistance start position indicated by said deceleration assistance start position information that has been learned.
